(19) United States
(12) Patent Application Publication
(10) Pub. No.: US 2006/0031152 A1
(43) Pub. Date: Feb. 9, 2006

(54) System and method to calculate the value of a non-tradable option such as an employee stock option, considering characteristics such as term structure in interest rates, volatility and dividends, constraints such as vesting and black-out periods as well as voluntary and involuntary early exercise patterns prescribed as a function of stock price, time or both

(76) Inventor: Gill R. Eapen, Groton, CT (US)

Correspondence Address: Gill R. Eapen, 94 Anchorage Circle, Groton, CT, 06340, US

(21) Appl. No.: 10/909,984

(22) Filed: Aug. 3, 2004

(51) Int. Cl. G06Q 40/00

(52) U.S. Cl. 705/37

(57) ABSTRACT

The current invention is a system and method to calculate the value of a non-tradable option such as an employee stock option, considering characteristics such as term structure in interest rates, volatility and dividends, constraints such as vesting and black-out periods as well as voluntary and involuntary early exercise patterns prescribed as a function of stock price, time or both. The stock price path is simulated using the drivers such as the future expectations of interest rates, volatility and dividends. In each simulation the exercise or expiry event of the option are determined applying explicit constraints such as vesting and black-out periods and voluntary or involuntary early exercise patterns based on stock price, time or both. In each simulation, the option value is calculated as the discounted value of the option at exercise or expiry (if it is in the money), discounted using the term structure of interest rates. The value of the option is calculated as the average of the option values obtained from a large number of such simulations. Similarly, the expected holding period and the probability of exercise in the money are calculated as the average of the time to exercise or expiry and the binary outcome of exercise in a large number of simulations.

### CROSS REFERENCE TO RELATED APPLICATIONS

The related art is represented by the following references of interest.

U.S. Patent Application Publication No. U.S. 20040128221 A1, published on Jul. 1, 2004 for Gurupdesh S Pandher, describes a method to identify multiple potential termination events for a given option (such as a stock option). Such multiple severance risks are then reflected in a model that can be used to provide substantially risk-neutral valuation of the option. The Pandher application does not suggest a system or method to calculate the value of a non-tradable option such as an employee stock option, considering characteristics such as term structure in interest rates, volatility and dividends, constraints such as vesting and black-out periods as well as voluntary and involuntary early exercise patterns prescribed as a function of stock price, time or both

### STATEMENT REGARDING FEDERALLY SPONSURED RESEARCH OR DEVELOPMENT

Not applicable

### REFERENCE TO SEQUENCE LISTING, A TABLE, OR A COMPUTER PROGRAM LISTING COMPACT DISK APPENDIX

Not applicable

### BACKGROUND OF THE INVENTION

The invention relates generally to the field of valuation of non-traded options such as Employee Stock Options Valuation. More particularly, the invention relates to a method and system to value non-traded options considering characteristics such as term structure (future expectations) in interest rates, volatility and dividends, constraints such as vesting and black-out periods as well as voluntary and involuntary early exercise patterns prescribed as a function of stock price, time or both.

Public and private companies typically provide their executives and employees with stock options as part of their compensation in an effort to entice employee performance consistent with share holder value maximization. Most often, these options are given with a specific duration and have constraints such as vesting and black-out periods. Vesting period prevents the holder of such an option from exercising the option till it is vested. Similarly, black-out periods will restrict exercise during certain pre-determined time due to expected major events such as capital structure changes. These option grants are not traded in the market-place and may have different tax treatments based on IRS rules on such option awards.

Because of the explicit constraints applied by the option grantor and the illiquidity due to non-tradability, these options behave very differently from publicly traded options. Further, the exercise behavior of the option holder (a critical determinant of the value of the option) also depends on the level of stock prices in the future and the amount of time left to the expiry of the option. It is also likely that such behavior is conditioned by the movement of stock prices in the past. As such, the traditional techniques, such as Black-Scholes are not directly applicable in the valuation of these options. The Financial Accounting Standards Board (FASB) is considering an accounting change that will require companies to expense these options in their financial statements. Currently, options given out at the current price of the stock are not considered to have any intrinsic value and as such companies are not required to expense them in the financial statements. However, it is well known that these option grants have value (although not as high as will be predicted by currently available techniques) and if the accounting change is effected, all companies will be required to expense them in their financial statements.

Even without any accounting change requiring companies to be explicit about the value of their options grants, it is the case that both the capital providers (investors, venture capitalists) as well as the managers of the companies, whether private or public, would like to have a better idea as to the value of the option grants as these grants effect a direct transfer of wealth from the owners (capital providers) to managers of the company.

Traditional option valuation method known as the Black-Scholes formula does not consider voluntary and involuntary early exercise, dividends and the term structure in interest rates and volatility and hence is not applicable in the valuation of non-traded options such as Employee Stock Options.

Traditional option valuation method known as the Black-Scholes-Merton formula does not consider voluntary and involuntary exercise, discrete dividends and the term structure in interest rates and volatility and hence is not directly applicable in the valuation of non-traded options such as Employee Stock Options.

The current invention is also superior to other existing option pricing methods such as binomial-trees as it allows prescription of multiple price path dependent early exercise events simultaneously and offers a flexible method and system to accommodate most type of constraints that may exist such as vesting and black-out periods.

### BRIEF SUMMARY OF THE INVENTION

The current invention is a method and system to value non-traded options considering voluntary and involuntary early exercise, exercise constraints such as vesting periods and black-out periods and the expected changes (term structure) in interest rates, volatility and dividends. According to one aspect of the present invention, the stochastic process related to the stock price is simulated using Monte Carlo simulation. Another aspect of the invention is the consideration of the term structure in interest rates, volatility and dividends in the simulation of the price process. The dividends can be discrete or continuous and can be described with an expected growth as well as the number of discrete dividends given out per time period (typically per year). Another aspect of the invention is the ability to prescribe the early exercise behavior of the option holder as a function of the stock price movement. Yet another aspect of the invention is the ability to prescribe the early exercise behavior of the option holder as a function of time. Another aspect of the invention is the ability to prescribe both time based and stock price based early exercise behavior together and let the system determine the dominant cross section of such behavior in the valuation process. This means that the user of the current invention can prescribe multiple independent early exercise criteria—such as stock price based and time based early exercise criteria—without worrying about which criteria will be the dominant one at different points in the life of the option. Another aspect of the invention is the ability to calculate the value of the option considering all specified characteristics and constraints. Another aspect of the invention is the ability to calculate the expected life of the option considering all specified characteristics and constraints. Yet another aspect of the invention is the ability to calculate the probability that the option will be exercised in the money.

The system to value non traded options such as Employee Stock Options considering price and time dependent voluntary and involuntary exercise behavior, exercise constraints and term structure of interest rates, volatility and dividends includes a computer system configured for carrying out the present invention.

The computer system may include any type of known computer, such as a personal computer or the like. Alternatively, the computer system may be functioning as a server/database of web site via the internet. A computer system configured for carrying out the present invention may include a computer, input devices, a display, and a printer. The computer may include a power interface, a central processing unit (CPU), a memory, a user interface(s), a network interface, a display, and a printer, that are all communicatively interconnected by a communication bus.

The memory may include random access memory (RAM) and read only memory (ROM). The ROM stores computer readable program code means that is read and processed by the CPU, and that causes the CPU to perform programmed functions. Movement and process of instructions as well as data is controlled and accomplished by the CPU. The RAM and the ROM may be connected to the microprocessor through several signal paths.

The CPU may execute various programs under the control of the operating system of the computer. Any computer readable program code means stored in the memory of the computer, or a computer useable medium having computer readable code embodied thereon may include means for calculating the option value, expected holding period and probability of exercise from the inputs provided such as stock price, strike price, vesting period, black-out period, number of dividends per unit time, growth rate in dividend, expected changes in interest rates, volatility and dividends, early exercise pattern as a function of stock price and early exercise pattern as a function of time.

### BRIEF DESCRIPTION OF THE DRAWINGS

FIG. 1 is a front perspective view of a computer system equipped with computer readable program code means for valuing investment opportunities according to the present invention.

FIG. 2 is a block diagram of a computer system equipped with computer readable program code means for valuing investment opportunities according to the present invention.

FIG. 3 is a screen shot of the computer program working on a computer system

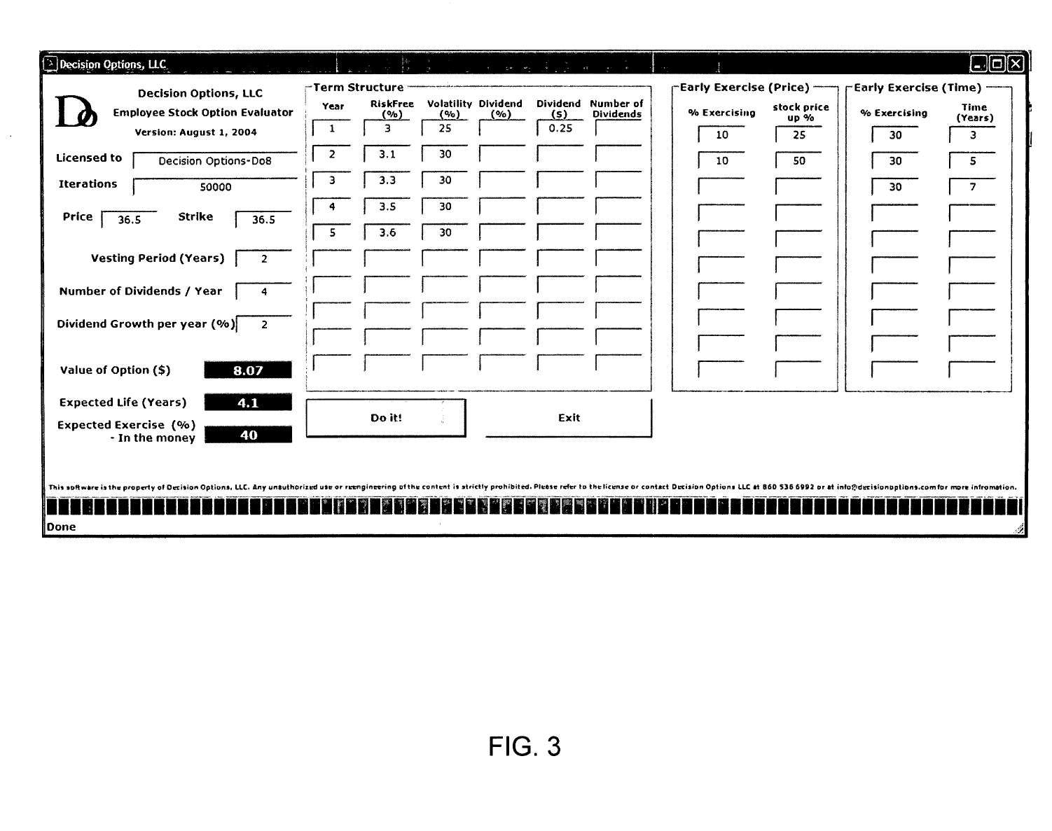

### DETAILED DESCRIPTION OF THE INVENTION

The invention relates generally to the field of valuation of non-traded options such as Employee Stock Options Valuation. More particularly, the invention relates to a method and system to value non-traded options considering voluntary and involuntary early exercise, exercise constraints such as vesting periods and black-out periods and the expected changes (term structure) in interest rates, volatility and dividends. The invention disclosed herein is, of course, susceptible to embodiment in many different forms. Shown in the drawings and described herein below in detail are preferred embodiments of the invention. It is to be understood, however, that the present disclosure is an exemplification of the principles of the invention and does not limit the invention to the illustrated embodiments.

The method of valuing non-exchange traded options such as Employee Stock Options considering price and time dependent voluntary and involuntary exercise behavior, exercise constraints such as vesting and black-out periods and term structure of interest rates, volatility and dividends has the following steps:
(a) A stochastic simulation is performed for the price process underlying the stock considering the characteristics of the price process (typically Geometric Brownian Motion (GBM), although other processes can also be used) and the fundamental characteristics of the process such as risk free rate (interest rates), volatility and dividends. The interest rates, volatility and dividends can also have a term structure, i.e. they can be time varying into the future.
(b) Constraints are imposed on the process such as vesting and black-out periods during which no exercise can take place.
(c) At each time step of the simulated price process, the early exercise pattern—both stock price based as well as time based in that order—is checked to see if the criteria are satisfied for an exercise.
(d) If the early exercise threshold is met, the option is exercised and the actual value (the difference between the stock price and the strike price) is discounted back to today using the term structure in interest rates. Also, the time to exercise as well as the probability of exercise are updated to reflect the actual outcome in this simulation.
(e) If the early exercise threshold is not met till the expiry of the option, the option is exercised at expiry if it is in the money or is allowed to lapse if it is not in the money. If the option is in the money at expiry, the corresponding value is discounted back to today using the term structure in interest rates. If the option is out of the money, the value is zero for this simulation of the price process. The time to exercise as well as the probability of exercise are updated to reflect the actual outcome in this simulation.
(f) The process is repeated for a large number of simulations (typically 50,000 or more) and the average expectation of value, time to exercise (or expiry) and probability of exercise are calculated and reported.

The system of the current invention has the following attributes:

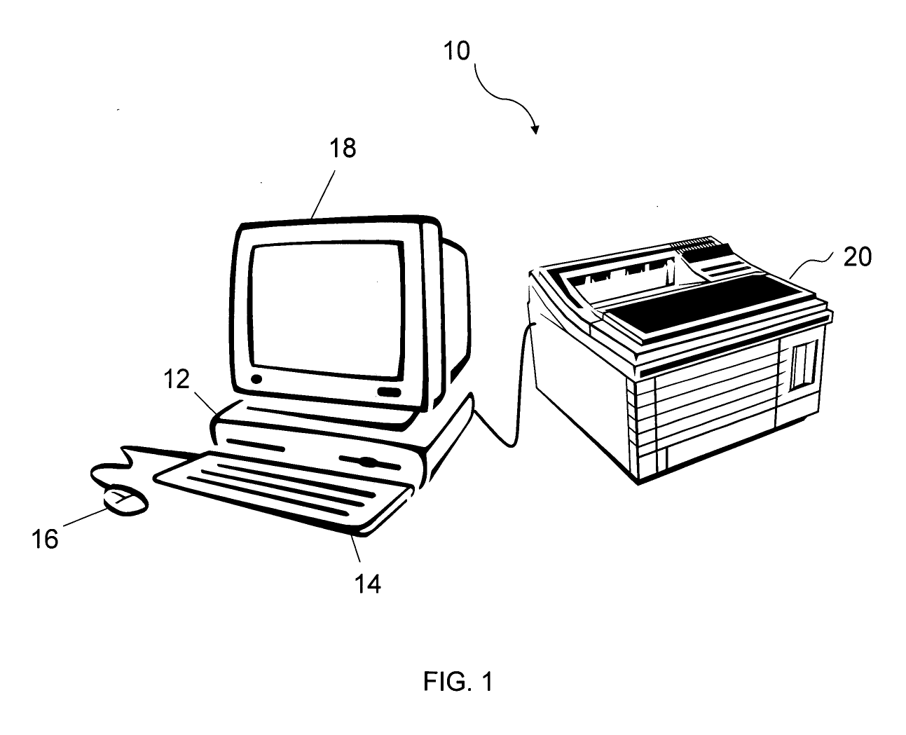

Referring to the drawings, FIG. 1 illustrates a system 10 that includes a computer system configured for carrying out the present invention. System 10 may include any type of known computer, such as a personal computer or the like. Alternatively, system 10 may be functioning as a server/database over the internet or local area network. As shown in FIG. 1, system 10 is configured for carrying out the present invention and includes a computer 12, input devices 14, 16, a display 18, and a printer 20. Input devices 14 and 16 are illustrated as a keyboard and a mouse, respectively. However, any input device may be employed according to the desires of the user. Display 18 may be any known display device, such as a cathode ray tube, a liquid crystal display, or the like. Printer 20 may be any known printing device. Additional components of an exemplary data visualization apparatus 10 comprising a digital computer are illustrated.

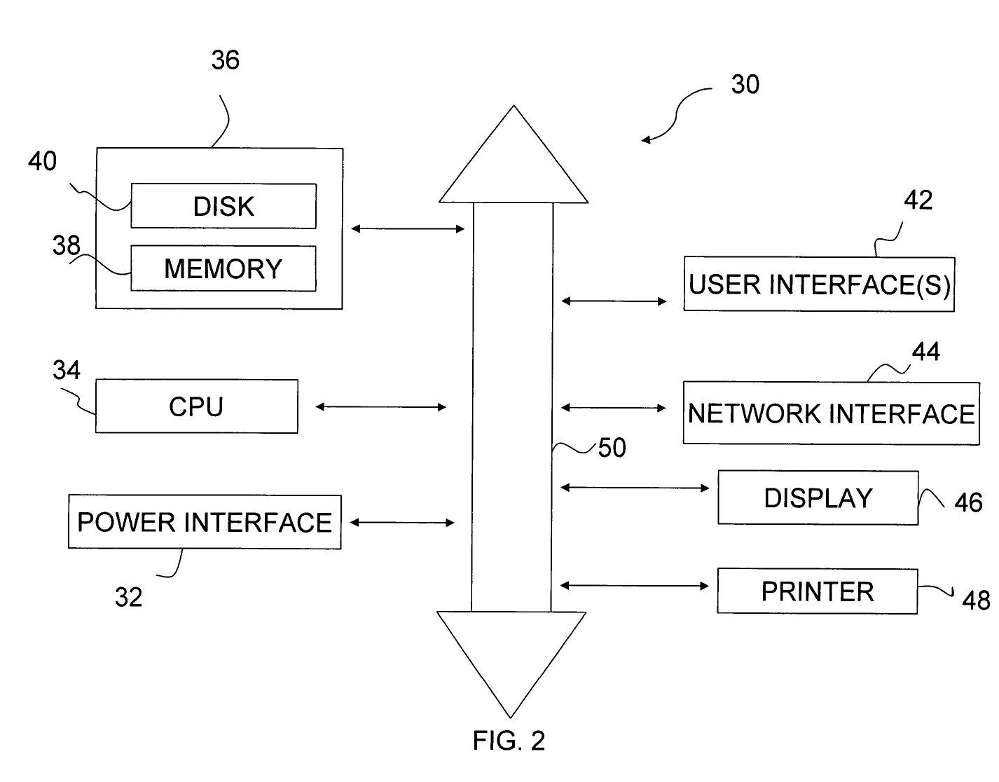

In FIG. 2, an illustrated configuration of a computer 30 includes a power interface 32, a CPU 34, a memory 36, a user interface(s) 42, a network interface 44, a display 46, and a printer 48, that are all communicatively interconnected by a communication bus 50. In the illustrated configuration, memory 30 includes memory 38 and disk storage device 40. Memory 30 represents computer useable media configured to store computer readable program code means and data. Exemplary memory 38 includes RAM and ROM. Exemplary disk storage devices 40 may include floppy disks, hard disks, CD-ROM devices, or the like.

The ROM stores computer readable program code means that is read and processed by CPU 34, and that causes CPU 34 to perform programmed functions. Movement and process of instructions as well as data is controlled and accomplished by CPU 34. The RAM and the ROM may be connected to the microprocessor through several signal paths.

CPU 34 may execute various programs under the control of the operating system of computer 30. The application program of the present invention is a stand alone software providing textboxes for all necessary inputs and calculated outputs. Any computer readable program code means stored in the memory of computer 30, or a computer useable medium having computer readable code means embodied thereon include the following features:
(a) Perform a stochastic simulation of the price process associated with the stock.
(b) Modulate standard price processes such as Geometric Brownian Motion (GBM) with future expectations of interest rates, volatility and dividends.
(c) Apply timing constraints such as vesting and black-out periods during which no exercise can take place.
(d) Apply the early exercise profile based on stock price and time and find the dominant action for each simulation.
(e) Calculate the option value, holding period and the binary outcome of an exercise/expiry for each simulation.
(f) Perform the simulation for a large number of simulations.
(g) Accumulate results from each simulation and report the average expectation of value, holding period and probability of exercise.
(h) Provide an input mechanism for stock price, strike price, vesting period, black-out period, number of discrete dividends, dividend growth, term structure in interest rates, term structure in volatility, term structure in continuous and discrete dividends, early exercise pattern as a function of stock price and early exercise pattern as a function of time.
(i) Report results including the expected value of the option, expected holding period and the probability of exercise.

I claim:

1. A method to calculate the value of a non-tradable option such as an employee stock option, considering characteristics such as term structure in interest rates, volatility and dividends, constraints such as vesting and black-out periods as well as voluntary and involuntary early exercise patterns prescribed as a function of stock price, time or both.

2. A method of claim 1, wherein the possible price paths of the stock are simulated considering price process characteristics such as type, term structure in interest rates, dividends and volatility.

3. A method of claim 1, wherein the explicit constraints such as vesting and black-out periods are applied in determining the occurrence of an option exercise event.

4. A method of claim 1, wherein other constraints such as voluntary and involuntary early exercise patterns based on stock price, time or both are considered in determining the occurrence of an option exercise event.

5. A method of claim 1, wherein the value of the option is calculated as the average option value in a large number of simulations of the price paths and exercise events satisfying the set constraints, discounted back to current time using the term structure in interest rate.

6. A method of claim 1, wherein the expected holding period of the option is calculated as the average time to exercise or expiry of the option in a large number of simulations of the price paths and exercise and expiry events satisfying the set constraints.

7. A method of claim 1, wherein the probability of option exercise in the money is calculated as the average of the binary exercise events in a large number of simulations of the price paths and exercise and expiry events satisfying the set constraints.

8. A system to calculate the value of a non-tradable option such as an employee stock option considering characteristics such as term structure in interest rates, volatility and dividends, constraints such as vesting and black-out periods and voluntary and involuntary early exercise patterns prescribed as a function of stock price, time or both, comprising of:
a central processing unit;
a memory;
an output device;
computer readable program code means stored in said memory, said computer readable program code in a machine-readable medium having stored thereon data representing sequences of instructions, the sequences of instructions which, when executed by a processor, cause the processor to perform the steps of selecting projects and allocating resources to departments/specialty such that the overall return to the company is maximized within a desired level of execution risk.

9. The machine-readable medium of claim 8, wherein the possible price paths of the stock is simulated considering price process characteristics such as type, term structure in interest rates, dividends and volatility.

10. The machine-readable medium of claim 8, wherein the explicit constraints such as vesting and black-out periods are applied in determining the occurrence of an option exercise event.

11. The machine-readable medium of claim 8, wherein other constraints such as voluntary and involuntary early exercise patterns based on stock price, time or both are considered in determining the occurrence of an option exercise event.

12. The machine-readable medium of claim 8, wherein the value of the option is calculated as the average option value in a large number of simulations of the price paths and exercise events satisfying the set constraints, discounted back to current time using the term structure in interest rate.

13. The machine-readable medium of claim 8, wherein the expected holding period of the option is calculated as the average time to exercise or expiry of the option in a large number of simulations of the price paths and exercise and expiry events satisfying the set constraints.

14. The machine-readable medium of claim 8, wherein the probability of option exercise in the money is calculated as the average of the binary exercise events in a large number of simulations of the price paths and exercise and expiry events satisfying the set constraints.
